(19) United States
(12) Patent Application Publication
(10) Pub. No.: US 2010/0156854 A1
(43) Pub. Date: Jun. 24, 2010

(54) DISPLAY SYSTEM, MODULE AND METHOD

(75) Inventors: Andrew John Fisher, Cambridge (GB); Timothy Holroyd Glauert, Cambridgeshire (GB)

Correspondence Address: BROOKS KUSHMAN P.C., 1000 TOWN CENTER, TWENTY-SECOND FLOOR, SOUTHFIELD, MI, 48075, US

(73) Assignee: DISPLAYLINK (UK) LIMITED, Cambridge (GB)

(21) Appl. No.: 12/063,303

(22) PCT Filed: Aug. 11, 2006
(86) PCT No.: PCT/GB06/03016

§ 371 Date: Feb. 8, 2008

(30) Foreign Application Priority Data
Aug. 13, 2005 (GB) 0516712.7

(51) Int. Cl. G09G 5/00

(52) U.S. Cl. 345/204; 345/1.3

(57) ABSTRACT

A display system comprises a plurality of display modules, a data network and a data processing device. The display modules and the data processing device are connected to the data network. Each display module has a memory for storing image data and the data processing device is arranged to transmit image data to each display module via the data network. The data processing device is further arranged to transmit a specific instruction to a display module, the specific instruction comprising details of image data to be transmitted from a first display module to a second display module.

This invention relates to a display system, a display module and a display method. The invention uses peer-to-peer operations to improve performance in a system involving multiple displays.

The development of display devices supports the creation of large displays composed of multiple display devices, as used in environments such as airports, advertising and point-of-sale displays. The image provided by such multiple display devices may be a series of the same image on each display, or may be a single large image made up of smaller component images, each component image being carried by a single display device.

A device such as a computer will be driving each individual display, with a data connection from the computer to each display. When one or more images need to be changed, the controlling computer must send new image data to each and all of the display devices that need to be updated. This requires an intensive use of resources, both in terms of the processing power of the computer and in bandwidth of the connections from the computer.

In some situations, each display device will have its own local memory representing the image on the screen. When the display is created from a single screen some redrawing operations can be implemented by copying pixels within the local memory of that display device. This is not possible when the display is composed of multiple independent devices, which do not share the same memory. The source pixels may be on a different screen from the destination pixels. In this case the conventional approach is for the controlling computer to re-send the pixel data from a copy of the display, or to read the pixels from the source display and then send them to the destination display.

It is therefore an object of the invention to improve upon the known art.

According to a first aspect of the present invention, there is provided a display system comprising a plurality of display modules, a data network and a data processing device, the display modules and the data processing device connected to the data network, each display module including a memory for storing image data, the data processing device arranged to transmit image data to each display module via the data network, and the data processing device being further arranged to transmit a specific instruction to a display module, the specific instruction comprising details of image data to be transmitted from a first display module to a second display module.

According to a second aspect of the present invention, there is provided a display module comprising a display screen for displaying an image, a memory for storing image data, a display driver for controlling the image displayed by the display screen, and a network interface for connecting to a data network, the display module arranged, following receipt of a specific instruction, to transmit image data to a second display module.

According to a third aspect of the present invention, there is provided a display method comprising transmitting image data from a data processing device to a plurality of display modules via a data network, transmitting a specific instruction to a display module and transmitting image data from a first display module to a second display module.

Owing to the invention, it is possible to provide a system of networked display devices that can transfer image data between display devices, under the control of a central data processing device. The invention provides a significant benefit by sending the pixels directly from one network-connected display device to another. The data does not go to or from the central computer. This reduces the load on the central computer and reduces the bandwidth on the network connection from the computer.

In the simplest embodiment, the display module comprises a display device connected to the data network, with all the components integral in the display device. Alternatively, the display module may comprise two separate devices, a display device and a display control device, which includes the display driver and network interface. In the latter embodiment, the display control device receives the image data from the data processing device and controls the corresponding display device accordingly. The data control devices can communicate with each other via the data network.

The images for the network-connected display modules are generated by the central data processing device and updated using various graphical operations to change regions of pixels. These operations are encoded and sent over the network to the modules. These devices also typically support operations to read pixel data from the screen and back to the host computer.

One example of an update operation involves copying a series of pixels from a source location on the display to a destination location on the display. This is known historically as BitBlt (BIT-aligned Block Transfer). BitBlt is important for operations such as moving windows or scrolling text and images. It is also used to copy images to and from off-screen areas for applications such as fast, flicker-free animation.

BitBlt is much more bandwidth-efficient than redrawing the destination area because the pixel data does not need to be sent over the network. All that is sent is a simple instruction containing the source and destination of the BitBlt.

Embodiments of the present invention will now be described, by way of example only, with reference to the accompanying drawings, in which:

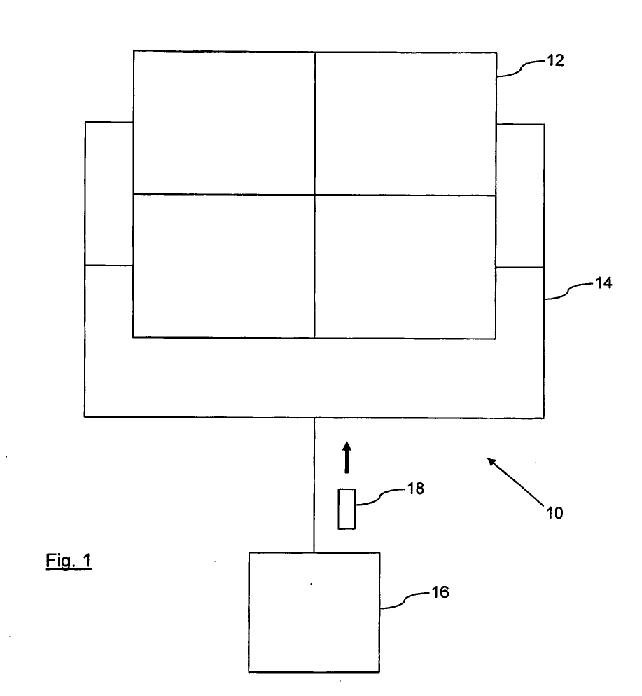

FIG. 1 is a schematic diagram of a display system,

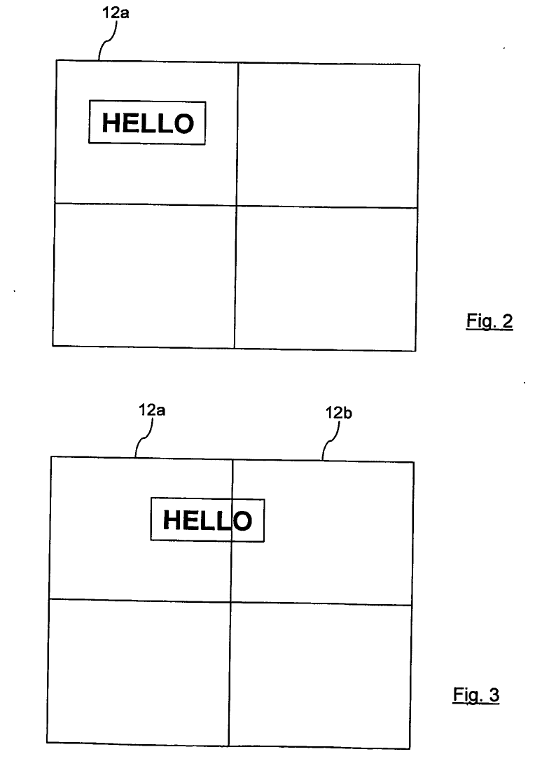

FIG. 2 is a schematic diagram of four display devices of the display system of FIG. 1,

FIG. 3 is a schematic diagram similar to FIG. 2,

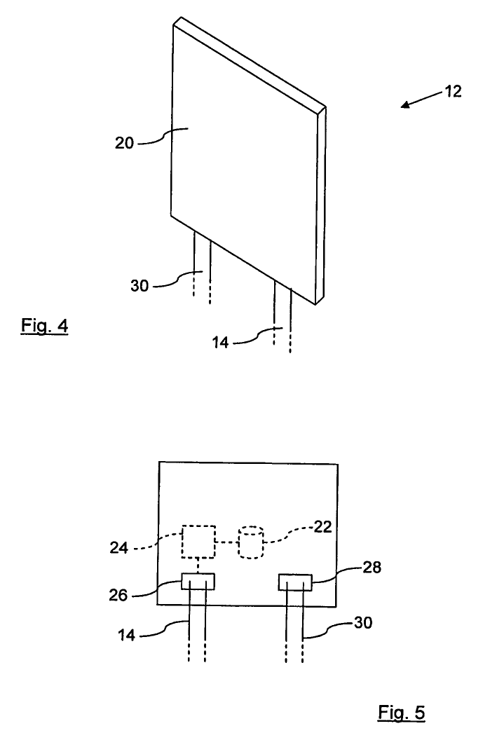

FIG. 4 is a perspective front view of a display device of the display system of FIG. 1,

FIG. 5 is rear plan view of the display device of FIG. 4,

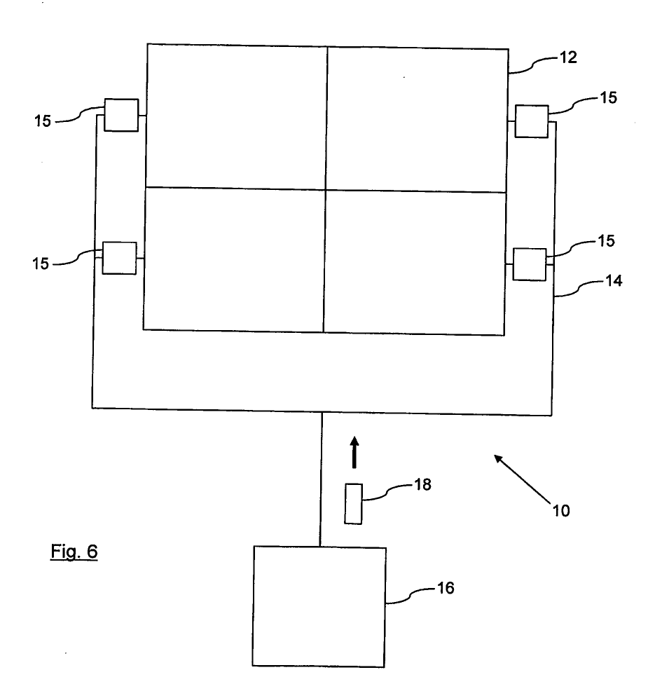

FIG. 6 is a schematic diagram of an alternative embodiment of the display system, and

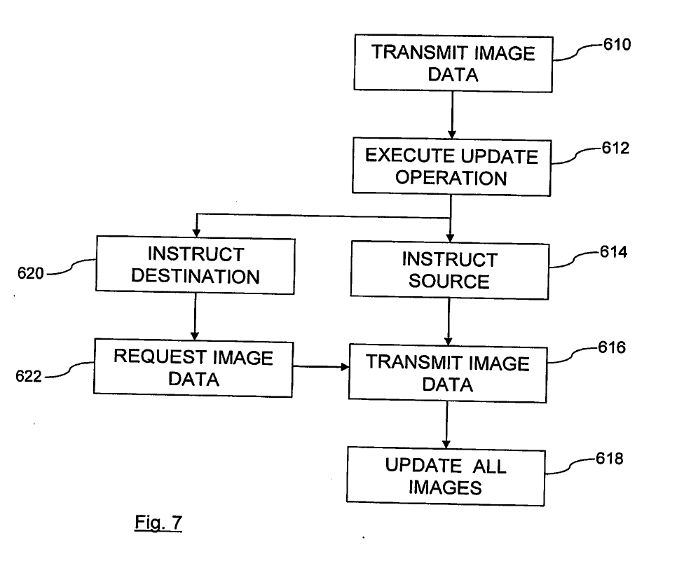

FIG. 7 is a flowchart of a display method.

FIG. 1 shows a display system 10 comprising a plurality of display modules in the form of display devices 12, a data network 14 and a data processing device 16. The display devices 12 and the data processing device 16 are connected to the data network 14. The data network 14 supporting the communication between the data processing device 16 and the display devices 12 can be any suitable general purpose data network such as described in the Ethernet and the 802.11 family of standards.

Each display device 12 (described below in more detail with reference to FIGS. 4 and 5) comprises a display screen for displaying an image, a memory for storing image data, a display driver for controlling the image displayed by the display screen, and a network interface for connecting to the data network 14. In some embodiments, all of these components will be housed within the same case. In other embodiments some of them may be separate. For example, the display screen may be a conventional PC display and the other components may be housed in a device connected to that display. This embodiment is described in more detail below, with reference to FIG. 6.

The data processing device 16 can be, for example, a computer or server, and is arranged to transmit image data 18 to each display device 12 via the data network 14. The data processing device 16 is controlling the display of the images by the display devices 12. Image data 18 is sent via the network 14 to each device for display by the respective display devices 12.

FIGS. 2 and 3 show two simplified examples of images displayed by the four display devices 12. The image displayed is an animation of “HELLO”, which moves from left to right across the top two display devices 12a and 12b. In FIG. 2, the motif “HELLO” is being displayed solely by the display device 12a, with the appropriate image data being sent by the data processing device 16 to the display device 12a.

The data processing device 16 executes an update operation, changing the images displayed to that shown in FIG. 3. The motif “HELLO” is now to be displayed by both display devices 12a and 12b, with a portion of the motif being displayed by each. When the computer 16 performs such an operation (such as a BitBlt operation) on a multi-screen display, it divides the operation into two parts, firstly operations where the source and destination image are to be displayed on the same screen, and secondly operations where the source and destination image are to be displayed on different screens.

When the new image to be displayed was already shown by the display device 12 (such as the letters “HELL” of “HELLO” in FIG. 3), the data processing device 16 will instruct the relevant display device 12 to perform the copy within its own memory. The data processing device 16 will instruct the display device 12 to update the image displayed by the display device 12 from the memory of that display device 12.

For operations of the second type, the data processing device 16 will cause the required pixels to be transferred directly from the source display device, 12a in FIG. 3, to the destination display device 12b. The data processing device 16 transmits a specific instruction to the display device, the specific instruction comprising details of the image data to be transmitted from the first display device 12a to the second display device 12b.

In this embodiment, the data processing device 16 will instruct the source display device 12a to send the pixels to the destination display device 12b using the standard drawing operations supported by the destination device 12b. In this case the destination device 12b will require no special knowledge that it is receiving data from another display device rather than the central computer 16.

In an alternative embodiment the computer 16 will instruct the destination display device 12b to read the pixels from the source device 12a using standard reading operations. In this case the source device 12a will require no special knowledge that it is sending data to another device 12b rather than the host computer 16. In a further embodiment, the host computer 16 may inform both the source and destination devices that a copy needs to take place. This may use an operation that is specially designed for the purpose.

In some embodiments, access to any given display module may be limited to certain components on the network, either for security reasons or because the display module can only accept one connection at a time. It may therefore be necessary for the system to arrange for the source display module to have the appropriate permissions with respect to the destination module for the duration of any operations between the two different display modules.

Methods for delegating such permission are well understood in the art, and the exact method chosen will depend on the system in place. An example implementation which may be relevant for particular systems is as follows:

A display module is configured only to accept instructions from one entity on the network at any one time, perhaps identified by its network address. One instruction a display module may send has the effect of adding, temporarily, another entity from which instructions may also be accepted. This second entity may be limited to a subset of possible instructions. For example, it may not be able to grant permissions to any further entities, and its own permissions may be revoked at any time by the first entity.

In a variation on this model, an entity has the right to send instructions to a display module based on passing a token as part of an instruction. An entity may therefore grant such rights to a second entity either by giving it a copy of the token, or by passing details to the display module and requesting an appropriate token which, when given, can then be handed to the second entity. In all such systems, prior to transmitting image data, the sending display module checks a permission strategy.

FIGS. 4 and 5 show the display device 12 in more detail. The display 12 includes a display screen 20 for displaying an image, a memory 22 for storing image data, a display driver 24 for controlling the image displayed by the display screen 20, and a network interface 26 for connecting to a data network. The display device 12 also includes a power supply 28 supplied by a power cable 30.

FIG. 6 shows an alternative embodiment of the display system, where each display module comprises a display device 12 and a display control device 15. The display control device in each module is an ultra-thin client device that controls the image displayed by the corresponding display device 12 (which can be a conventional display such as an LCD monitor). The display control devices connect to the data network 14 and contain the display driver and the local memory storing the image data. When the data processing device 16 transmits an instruction to a display module, it will be received by the display control device 15 of that module, which will then handle the push or pull of image data to or from another data control device of another module.

FIG. 7 summarises the display method executed by the display system 10. The data processing device 16 transmits the image data 18 to each of the display devices 12 in the display system 10 (step 610). The data processing device 16 executes an update operation (step 612), which may occur periodically or may occur in response to a specific request. The update operation is for the purpose of determining the new images to be shown by the display devices 12, and for working out which elements of the old images can be reused in the creation of the new image.

For any and all image data that is present at a source display device 12 that can be used by a destination device 12 in the creation of a new image, then (in a first embodiment) the data processing device 16 will instruct the source display device 12 (step 614) by transmitting a specific instruction to the source display device 12 comprising the details of the image data to be transferred to the destination device 12.

Following instruction of the source display device 12, that device (step 616) will transmit the image data via the data network 14 (rather than by or via the data processing device 16) to the destination display device 12. At step 618, the images displayed by the display devices 12 are updated.

In an alternative embodiment, the data processing device 16 instructs the destination device 12 to acquire the image data that it needs from the source device 12 (step 620). The destination display device will then transmit a request to the source display device 12 (step 622), and the required image data will be transmitted, at step 616.

Depending on the nature of the graphics protocol and the display devices, it may be necessary for the data processing device 16 to impose an order on the sequence of updates to ensure that image data which is required as source data is not overwritten by another operation before it is transferred to the destination display device.

In some embodiments, the image data operations are performed in such a way that they are not immediately visible on the display devices, for example by executing them in a background framebuffer. The data processing device may then signal to the display devices that the operation is complete and the transformations can then be made visible on the display. This synchronisation makes the operations appear less fragmented to the user.

In a simple implementation, a display device receiving an instruction from the data processing device reports back to the data processing device when the display device is ready to display the results of that instruction but does not immediately make those results visible. If, as part of that instruction, the display device has sent instructions to other devices, it does not report back as ready until it has received such an assurance from those other devices. When all involved devices are known to be ready, the data processing device issues an instruction causing them to make the results of the instruction visible.

On a network supporting broadcast or multicast functionality, the data processing device may send out a single instruction which is received by all involved devices causing them to update simultaneously. Other systems for synchronising activities across a network are well known in the art.

1. A display system comprising a plurality of display modules, a data network and a data processing device, the display modules and the data processing device connected to the data network, each display module including a memory for storing image data, the data processing device arranged to transmit image data to each display module via the data network, and the data processing device being further arranged to transmit a specific instruction to a display module, the specific instruction comprising details of image data to be transmitted from a first display module to a second display module.

2. A system according to claim 1, wherein the display module comprises a display device.

3. A system according to claim 2, wherein the display module includes a display control device, the display control device connected to the data network, and the display device connected to the display control device.

4. A system according to claim 1, wherein the data processing device is arranged to transmit the specific instruction to the first display module, and the first display module is arranged to transmit the image data to the second display module.

5. A system according to claim 1, wherein the data processing device is arranged to transmit the specific instruction to the second display module, and the second display module is arranged to request transmission of the image data from the first display module.

6. A system according to claim 1, wherein each display module further includes a display screen for displaying the received image data.

7. A system according to claim 6, wherein the data processing device is further arranged to instruct a display device to update the image displayed by said display device from the memory of said display device.

8. A display module comprising a display screen for displaying an image, a memory for storing image data, a display driver for controlling the image displayed by the display screen, and a network interface for connecting to a data network, the display module arranged, following receipt of a specific instruction, to transmit image data to a second display module.

9. A display module according to claim 8, wherein the display module comprises a display device.

10. A display module according to claim 9, wherein the display module includes a display control device, the display control device comprising the display driver and the network interface.

11. A display module according to claim 8, and further arranged, upon receipt of a specific instruction, to update the image displayed by said display screen from the memory of said display module.

12. A display method comprising transmitting image data from a data processing device to a plurality of display modules via a data network, transmitting a specific instruction to a display module and transmitting image data from a first display module to a second display module.

13. A method according to claim 12, wherein the specific instruction is transmitted to the first display module.

14. A method according to claim 12, wherein the specific instruction is transmitted to the second display module, and further comprising requesting transmission of the image data from the first display module.

15. A method according to claim 12, and further comprising transmitting a specific instruction to a display module to update the image displayed by said display module from the memory of said display module.

16. A method according to claim 12, and further comprising, prior to transmitting image data, checking a permission strategy.
